(19) United States
(12) Patent Application Publication
(10) Pub. No.: US 2026/0260269 A1
(43) Pub. Date: Sep. 3, 2026

(54) OPTIMIZING BIDS FOR MEDIA CONTENT IN A DEMAND-SIDE PLATFORM

(71) Applicant: VIANT TECHNOLOGY LLC, Irvine, CA (US)

(72) Inventors: Xin Chen, Irvine, CA (US); Fabrizio Blanco, Beverly Hills, CA (US)

(73) Assignee: VIANT TECHNOLOGY LLC, Irvine, CA (US)

(21) Appl. No.: 19/555,672

(22) Filed: Mar. 3, 2026

Related U.S. Application Data
(60) Provisional application No. 63/766,272, filed on Mar. 3, 2025.

(51) Int. Cl. G06Q 30/0273; G06Q 30/0241

(52) U.S. Cl. CPC G06Q 30/0275; G06Q 30/0249

(57) ABSTRACT

A system and method provide the ability to optimize a bid in a real time bid (RTB) auction. A metadata producer (MDP) application includes an online adaptive learning component that autonomously produces campaign metadata including budget pacing, retrieves historical RTB auction data, and generates a price adjustment variable. Mediator application(s) handle RTB auctions, receive a predicted offer price and predicted key performance index (KPI) performance metrics from a machine learning (ML) model, and choose the bid offer price based on the price adjustment variable, the predicted offer price and predicted KPI performance metric. The ML model predicts a win-price prediction and KPI performance metrics for the mediator. A feedback loop provides bids and impression delivery information from the mediator application to the MDP application.

### CROSS-REFERENCE TO RELATED APPLICATIONS

This application claims the benefit under 35 U.S.C. Section 119 (e) of the following co-pending and commonly-assigned U.S. provisional patent application(s), which is/are incorporated by reference herein:

Provisional Application Ser. No. 63/766,272, filed on Mar. 3, 2025, with inventor(s) Xin Chen and Fabrizio Blanco, entitled “AI Bidding-Bid Optimizer,” attorneys' docket number 257.0104USP1.

### BACKGROUND OF THE INVENTION

### 1. Field of the Invention

The present invention relates generally to demand-side platforms, and in particular, to a method, apparatus, system, and article of manufacture for optimizing bids for media content in a demand-side platform.

### 2. Description of the Related Art

Real time bidding (RTB) is a form of programmatic advertising that allows for the buying and selling of digital ads in real time. When users engage with any internet connected environment—such as Connected TV (CTV), online video, websites, mobile apps, audio streaming, digital radio, podcasts, in-game environments, digital out-of-home (DOOH), retail media networks, or other programmatic channels—a real-time auction occurs where advertisers bid and compete for available ad inventory. If the advertiser has the highest bid in the auction, their ad is displayed on the internet connected environment. Real-time bidding (RTB) is facilitated through an ecosystem that includes supply-side platforms (SSPs), ad exchanges, and demand-side platforms (DSPs). SSPs and ad exchanges operate on the supply side of the marketplace and provide similar functionality in enabling publishers to make advertising inventory available for automated sale. A DSP is a technology platform that enables advertisers to evaluate, bid on, and purchase advertising impressions. In many implementations, SSP and exchange functionality are integrated within a single platform.

Through real-time bidding, publishers and advertisers are able to sell and purchase advertising impressions in an automated manner. An SSP or ad exchange provides programmatic software that enables publishers to manage and offer impressions to multiple potential buyers. By interfacing with multiple DSPs and other buying platforms, SSPs and exchanges expose publisher inventory to a broad set of advertisers, conduct auctions, and apply pricing controls. This expanded access can increase competition for impressions and enable publishers to manage pricing parameters and other controls in order to optimize revenue.

A DSP is programmatic software for advertisers that provides automated, centralized media buying from multiple sources. A DSP is driven by the demand side of the advertising equation—advertisers seek inventory that will help them reach the right audiences at the right time, within a defined budget.

On the RTB side, the environment is highly dynamic—both the quantity of supply and the equilibrium auction prices of the supply may fluctuate over time due to changing supply and demand. On the DSP side, campaigns with more un-spent budget would accept higher prices due to higher demand, while campaigns fulfilling their budget would like to further reduce their media cost. It is desirable for predictive systems that generate bidding prices to not only price each bidding opportunity differently, but also automatically adjust based on supply-demand dynamics.

In view of the above, it is desirable to provide an artificial intelligence (AI)/ML system to utilize within an RTB system to generate bid pricing and strategies that maximize media cost savings for both percent of spend customers (i.e., customers that have a percentage of total company revenue allocated for advertising) as well as for fixed price customers (i.e., customers that have a fixed amount allocated for advertising) in a dynamic manner that accounts for supply-demand dynamics.

### SUMMARY OF THE INVENTION

Embodiments of the invention provide an AI/ML bid optimizer that provides an AI/ML-driven bidding solution within a demand-side platform (DSP) that assists advertisers achieve superior results in their programmatic buying efforts by taking into account changing supply-demand dynamics in an autonomous manner. Embodiments of the invention are powered by a deep learning neural network trained on a large database of a bid streams that is capable of processing millions of requests per second. Such a neural network results in improvement to bid price discovery, real-time data processing, and predictive ad performance capabilities. On a buy-side only platform, embodiments of the invention maximize advertising efficiency and effectiveness by securing efficient rates for advertisers, many of which are focused on delivering strong return on investment for their campaigns.

### BRIEF DESCRIPTION OF THE DRAWINGS

Referring now to the drawings in which like reference numbers represent corresponding parts throughout:

FIGS. 1A and 1B illustrate two price adjustment strategies in accordance with one or more embodiments of the invention;

FIG. 2 illustrates the computer-implemented architectural design for bid optimization in accordance with one or more embodiments of the invention;

FIG. 3 illustrates a mathematical model of the adjustment ratio, KPI Slope, and Evaluation Metrics in accordance with one or more embodiments of the invention;

FIG. 4 illustrates an observer pattern workflow to synchronize a budget allocation/pacing service with a bid optimizer online adjustment service in the MDP in accordance with one or more embodiments of the invention;

FIG. 5 illustrates a graph of the KPI slope in accordance with one or more embodiments of the invention;

FIGS. 6A-6C illustrate the iterative constrained optimization process for fitting a quadratic function to sample data points in accordance with one or more embodiments of the invention;

FIG. 7 illustrates the logical flow for optimizing a bid in a real time bid (RTB) auction in accordance with one or more embodiments of the invention;

FIG. 8 is an exemplary hardware and software environment used to implement one or more embodiments of the invention; and

FIG. 9 schematically illustrates a typical distributed/cloud-based computer system in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide for AI/ML based bidding within a DSP system that includes multiple innovations, including (but not limited to):
1. Online adaptive learning (with a hybrid loss function) to automatically adjust pricing based on supply-demand dynamics;
2. Data-centric re-labeling heuristics for training an ML model to predict the ideal winning price in RTB auctions (e.g., the ML model predicts a winnable auction price of an RTB auction, not considering budget pacing or KPI [key performance index] performance);
3. A control feedback loop incorporating a runtime architecture that orchestrates components such as a metadata producer, a bidder, and a TensorFlow model (i.e., a pre-trained reusable ML model that can be downloaded from a repository of ML models); and
4. Monitoring and alerting systems for end-to-end oversight.

### Architectural Design

The following describes some principles/paradigms/assumptions that are related to engineering choices of embodiments of the invention.

Deterministic v. Probabilistic

In deterministic models, the output of the model is fully determined by the parameter values and the initial values, whereas probabilistic models incorporate randomness/uncertainty in their outputs (such as sampling from a probabilistic distribution).

While probabilistic models usually require a large hidden/latent variable space to generate outputs, deterministic models only need a small number of parameters to determine outputs.

While the approximation error of a deterministic model could be directly measured by differences (such as MSE [mean squared error], HingeLoss [i.e., a one-sided loss function that maximizes the margin between classes]) between outputs and ground truths among individual data points, the goodness of fit of a probabilistic model is measured by cross-entropy (requiring a larger sample size to be statistically significant).

Demand is the driving force behind trading prices: if demand >supply the price is driven higher; if demand <supply, the price is driven lower.

The assumption of the first principle is that supply could be considered as a steady flow of inventory that is more or less independent from the demand.

### Principle of Least Action for System Efficiency

The principle of least action (stationary action) for system efficiency is that the systems that takes the least action to cover the same distance is the most efficient one, in addition, the path this system takes is stationary, i.e. if an extremely small (infinitesimal) perturbation is added to this path, then the first order difference of the efficiency equals to zero.

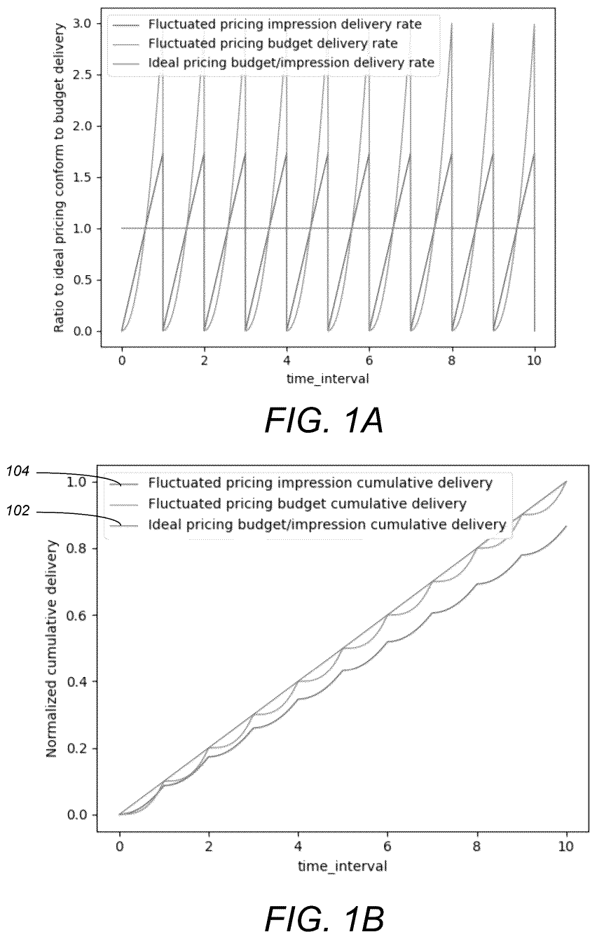

This idea might be illustrated in delivery rate and cumulative delivery simulations. FIGS. 1A and 1B illustrate two price adjustment strategies in accordance with one or more embodiments of the invention. More specifically, FIG. 1A illustrates delivery rate simulations and FIG. 1B illustrates cumulative delivery simulations. In such simulations, two price adjustment strategies can be compared: a fluctuated pricing strategy that makes frequent, large corrections to the price and an ideal, stationary pricing strategy. Assuming there was a steady inventory supply from the bid stream and the impression delivery rate is proportional to the trading price.

Noting that increasing bidding price has a compounded effect on budget delivery, not only the clearing price would increase but also the amount of impressions increases due to increased winning rate (as illustrated in FIG. 1A). Although the two strategies may deliver the same amount of budget, the ideal stationary pricing strategy (see FIG. 1B-102) delivers more impressions than the fluctuated pricing strategy (FIG. 1B-104 in blue color) and is more efficient (i.e., lower ECPM [effective cost per mile]). In other words, the sooner the system could tune itself into the equilibrium (a stationary pricing that matches to the demand) and stop fluctuating, the more efficient it would be. In the case of managed service with an impression cap, as long as impressions are not from fixed price deals, there still exists an equilibrium price where the quantity of winnable supply meets the demand (impression cap). A less fluctuated pricing strategy that reaches the equilibrium price faster might still provide better efficiency (such as lower media cost).

### High Level Design Features

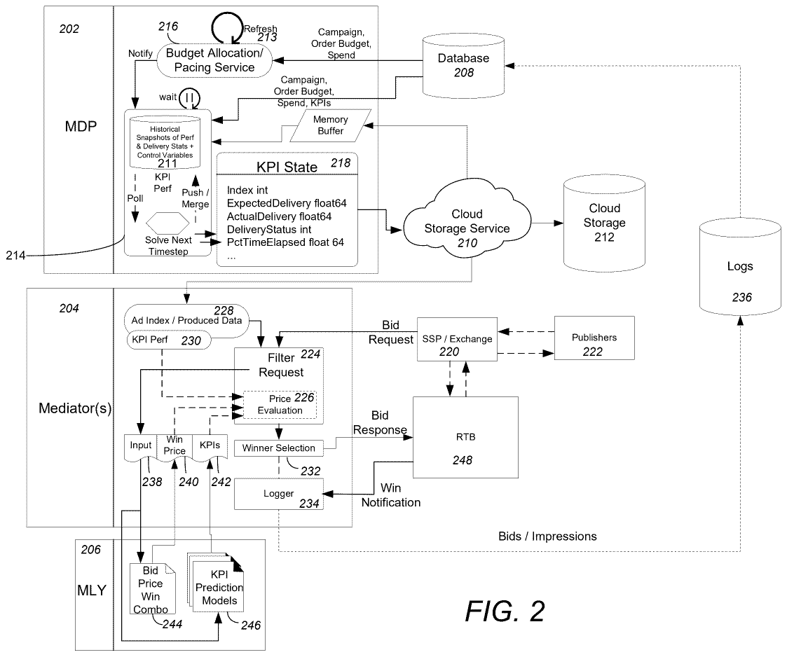

FIG. 2 illustrates the computer-implemented architectural design for bid optimization in accordance with one or more embodiments of the invention. Generally, there are three components: Metadata Producer (MDP) 202, Mediator 204, and a TensorFlow ML model (MLY) 206. Each of these components will be described in further detail below.

### Metadata Producer (MDP) 202

The MDP 202 pulls data from a database 208 (e.g., a MySQL database) and a cloud object storage service/system 210 (e.g., Amazon's Simple Storage Service (S3) 210) that retrieves data from cloud storage 212 (e.g., Big Query (GBQ) tables/storage warehouse available from Google™). Pulling the data produces a variety of campaign metadata (e.g., budget pacing) during each refresh cycle (every x minutes).

MDP 202 contains the online adaptive learning component 214 (also referred to as an online adjustment service 214) of a Bid Optimizer (of embodiments of the invention), which is synchronized with a budget allocation/pacing service 216 (see further description below), retrieves historical data 211 and performs a forward-looking prediction of price adjustment variables (in the Key Performance Index (KPI) State table/database 218) to be used in the Mediator 204 in the next cycle. Details about how bidding control variables are updated in relation to budget pacing and KPI performance status are discussed in further detail below.

In particular, for each (AdOrderId, bidAlgorithm) pair, MDP 202 keeps multiple historical snapshots 211 of KpiStates 218 (i.e. performance and delivery stats, as well as values of control variables being used). In other words, each adOrder-Algo pair contains a sequence of time snapshot 211. For CPM ad orders, the following key metrics may be included in each snapshot 211: DeliveryLabel (a binary label indicating if delivery is behind/ahead during each quota allocation cycle); EvalMetric (a numeric value<=1; the value would be close to 1 when delivery is on-track (i.e., optimal trade-off between cost and delivery), and lower than 1 in case of under/over delivery); and AdjustmentRatio (a multiplier for ML win price adjustment).

At each refresh cycle 213, if there is enough new data, a new KpiState 218 would be created and added to a queue (the oldest KpiState 218 would be discarded if the queue has reached maximum length), otherwise the data would be merged into the last KpiState 218. Updated values of control variables would be computed based on multiple historical snapshots 211 of KpiStates 218.

The hypothesized scenario is there is a learning agent (e.g. an auto-adjust algorithm 214) facing a dynamically changing environment (like RTB bidding), the learning agent 214 doesn't know what would happen in the future, but it could interact with environment via actions (e.g. changing certain adjustment values) and could receive responses from the environment via a feedback loop (for instance, the agent 214 could take measurements from the environment to evaluate its latest actions).

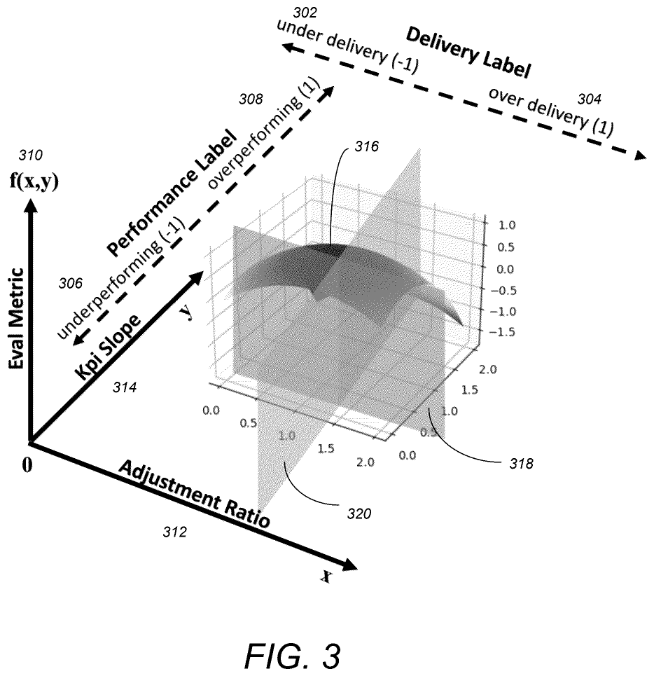

The RTB bidding environment is known to be very dynamic, both delivery and performance time sequence can be extremely noisy due to factors such as client changes, supply fluctuations, etc. In addition, there is no consistent ground-truth labels for a certain action (e.g. previous rules of thumb might no longer work when the environments change). Due to these challenges, instead of choosing heuristic approaches (which applies heuristic rules from domain experts), embodiments of the invention adopt an online optimization approach to find solutions based on historical actions 211 and signals collectively. More specifically, the update of control variable values is performed via adaptive online gradient descent with a hybrid value function. The hybrid value function is a combination of a quadratic regression function that models the relation between control variables and metrics, and a hyperplane based classification function (see FIG. 3). In this regard, FIG. 3 illustrates different perspectives of a mathematical model of adjustment ratio, KPI slope, and evaluation metrics in accordance with one or more embodiments of the invention. This hybrid function serves two purposes: (1) it classifies data points into different labels (e.g. under-delivery 302 vs. over-delivery 304, underperforming 306 vs. over-performing 308); and (2) it numerically approximates the reward metrics 310.

The optimal values of adOrder+bidAlgorithm control variables (adjustedRatio 312 and kpi_slope 314) in the next time step can be obtained via gradient descent among data points (historical snapshots 211). An additive loss function MSELoss+SquaredHingeLoss may be used during the gradient descent process to ensure the data points are on the right side of the quadratic function (see FIG. 3 which divides the data points into different quadrants). and the metric approximation error is reduced. After the gradient descent is converged, the value function would provide closed form solutions of optimal control variable values. The optimal values of control variables (e.g., adjustedRatio 312 and kpi_slope 314) are then passed from MDP 202 to the mediator 204 bidder and would be used in the price valuation filter 226 to compute the final adjustedOfferPrice. One candidate formula could be:

$$mlPredictWinPrice * adjustedRatio ( adOrder , bidAlgorith ) * ( 1. + ( predictedKpi ( bidRequest , adOrder ) - targetKpi ( adOrder ) ) \text{} / targetKpi ( adORder ) ) * kpi\_slope ( adOrder , bidAlgorithm )$$

### Mediator 204

Mediator 204 handles OpenRTB (a protocol for conducting RTB auctions) auctions, receives RTB requests from a SSP/Exchange 220 (e.g., that communicates with publishers 222), and analyzes such RTB requests (e.g., via filter request module 224). More specifically, the bid requests are filtered at 224 using a price evaluation 226 that is based on the bid requests from SSP 220, and the advertising indices/produced data 228, and KPI Performance criteria 230 retrieved from MDP's cloud storage service 210. Once filtered, mediator 204 makes bid/no-bid decisions, chooses offer prices for auctions (e.g., selects the bid expected to win 232), and logs bids and impressions (e.g., via logger 234 to a database of logs 236). Specifically, when a Bid Optimizer is enabled, the offer prices 232 are determined based on the methodology described herein.

### MLY 206

MLY 206 is also known as Tensorflow ML model or an Explorance MLY. MLY may consist of a commercial (or custom) solution that uses machine learning models for natural language processing (NLP) to analyze qualitative text feedback. In embodiments of the invention, MLY 206 consists of the Tensorflow ML model with caching capabilities. Mediator 204 calls the MLY service 206 (providing input 238 based on the filtered bid requests 224) to get ML predictions (e.g., win price 240 and KPIs 242) back. The ML models may include a win-price prediction model 244 and KPI prediction models 246. The bid win-price predication model 244 predicts the offer price 240 to win an auction, while the KPI prediction models 246 predict KPI performance 242 such as click-through rate.

It may be noted that MLY 206 may train an ML model with supervised learning. In such systems, ML model prediction is a static process-once trained, the model weights are frozen. In other words, given the same inputs, the model always produces the same output, and as such is unable to adapt to the changing environment (i.e., supply-demand dynamics) by itself. Consequently, embodiments of the invention extend well beyond the MLY model predictions taking into account supply-demand dynamics as described herein.

Bidding and delivery information from the logs 236 are fed into a database 208 (e.g., a MySQL database), thereby creating a feedback loop from Mediator 204 to MDP 202, allowing bidding and delivery information to be sent back to the online adaptive learning component 214 of a Bid Optimizer.

### Low-Level Design Features/Workflow

The following description provides an overview of the low-level design features of the architecture described above.

### Automated Budget Cap Decision Based on Budget Separation Test Plan

In embodiments of the invention, a demand side budget separation may be utilized that is applied to a specified list of AlgoIDs. AlgoID partitions campaign traffic/budget into isolated buckets, each with its own learning state and control parameters. This enables (i) clean A/B comparisons without cross-interference, and (ii) multi-agent exploration/exploitation, where a probing bucket uses more aggressive updates to explore a wider response range and generate additional data that can be incorporated to improve/accelerate the primary bucket's online learning and savings.

A bidding algorithmic framework of embodiments of the invention may perform supply-side traffic separation via coin tossing according to algorithmic allocation percentage during one of the Mediator filters 224. In order to perform proper A/B testing between test and control algorithms, the test and control algorithms shouldn't compete on the same RTB request. In addition, their demand side budget needs to be separated (so that each algorithm has its separated budget pool defined by its allocation percentage). The goal is to automate the budget separation test plans which meet the following requirements:
1. The system could support multiple budget separation strategies simultaneously, and use these strategies to decide the bidding algo budget separation logic on the ad order level.
2. All test plans follow the same template, enabling swift deployment of product test plans via CI_DYNAMIC_CONFIG (a dynamic configuration file used for different pipelines based on runtime conditions, branch names, or file changes) changes.

The JSON (JavaScript Object Notation) example below shows an example of multiple A/B test plans which could apply different budget separation strategies.

JSON Example

1 [{
2 ″id″ : 1,
3 ″name″ : ″test_plan_percentage_of_spend_self_service_cpm″,
4 ″account_sub_types″ : ″td″,
5 ″business_model_ids″ : ″2″,
6 ″campaign_goals″ : ″5″,
7 ″campaign_goal_prioritizations″ : ″2″,
8 ″budget_separation_algo_ids″ : ″6,7″
9 },
10 {
11 ″id″ : 2,
12 ″name″ : ″test_plan_fixed_price_managed_service_cpm″,
13 ″account_sub_types″ : ″direct″,
14 ″business_model_ids″ : ″1″,
15 ″campaign_goals″ : ″5″,
16 ″campaign_goal_prioritizations″ : ″2″,
17 ″budget_separation_algo_ids″ : ″6″
18 },
19 {
20 ″id″ : 3,
21 ″name″ : ″test_plan_percentage_of_spend_self_service_kpi″,
22 ″account_sub_types″ : ″td″,
23 ″business_model_ids″ : ″2″,
24 ″campaign_goals″ : ″3,6″,
25 ″campaign_goal_prioritizations″ : ″1,2″,
26 ″budget_separation_algo_ids″ : ″6″
27 }]

For example, the first A/B test plan is related to testing a feature among CPM ad orders from percentage-of-spend+selfservice campaigns. Likewise, the second and the third test A/B plan involve different combinations of campaign goals and account/business types. The first test would require more traffic than the second and the third, more specifically, assuming algo_6 gets 5% allocation and algo_7 gets 10% allocation, then a total of 15% supply traffic and 15% of budget delivery cap would be allocated to this test.

In order to support multiple bidding algorithm budget separation strategies for different groups of A/B tests that evolve over time, BitSet based feature matching could be applied. Such an implementation may utilize an existing BitSet library. Firstly, strategies are represented as JSON arrays and each strategy is defined as a group of features (such as account sub type, business model ID, etc.), and each feature contains a set of values. Each strategy is then converted into a BitSet that contains multiple unit 64 words. The name of each feature (accessed via Golang structure reflection—e.g., in the Go programming language) receives an integer index, this index decides the starting bit offset of the unit 64 words associated with that feature (the number of words per feature is configurable). Words used by different features are mutually exclusive. The values of each feature are converted to Strings, which then pass through a deterministic hash function and a modulo operation to obtain its bit position. (A deterministic hash function is chosen to handle all feature values, not just feature values exists among the strategies, it is shown that when the cardinality is small, such as values range from “1” to “9”, there is no hash space collision within a 64 bit unit 64 word).

During the matching time, it is observed that any strategy that could match to a specific permutation of algoritm+ad order+campaign goals+account & campaign features must also be its SuperSet. So the matching can be performed via a bitwise AND operation (after the permutation to be matched is converted to a BitSet). If the resulting BitSet value is equal to the BitSet value of the permutation, then the permutation matches to the strategy.

A separated budget cap may be applied to an ad order-algo pair if its feature permutation could match to any bidding algo budget separation strategies.

### Bidding ALGO Budget Separation

During each refresh cycle 213, the Budget Allocation Pacing Service 216 (also referred to as a bidAlloc service) calls doBidAllocations( ) which performs the following top-down budget allocation decision process:
1. Update Campaign Budget from Flight, Day Pacing, budget rollover etc.
2. Evaluate Campaign spend (with estimated spend) vs. budget
3. Sets the Daily Budget for pacing ad orders, Campaign Budget shifting between under-delivery and achieving delivery ad orders
4. Update Ad Order Budget from Flight, Day Pacing, budget rollover, etc.
5. Evaluate Ad Order spend (with estimated spend) vs. budget
   a. (all above can be reused) pave the way for bid algorithm split
   b. (Everything Leads up to the final split has already been decided without knowing how bid algo budget get separated.)
   c. (we don't need to dynamically shift budget across algo to maximize delivery, we just want fairness and to keep the budget separated)
6. allocateBid, calculateEstimatedCounts

Most of the complexities (flights, daily front-loading, intra-day budget shifting, etc.) happen before the budget finally reaches an ad order. Once the budget reaches an ad order, the budget cap can be dynamically partitioned by bidAlgos: (Constrained Ad budget+Ad Daily Total Spend)*algoWeight. In other words, how the ad order sum got split among bidAlgos doesn't affect how the sum arrived at the ad order from the top.

Any unspent budget on the algo level would automatically get rolled over to the next day, again going from the top to down to an ad order before split by algo. So even if some bidAlgos might spend faster, their budget allocation would still be following the algoWeight at any moment of time.

Two new budget statuses may be introduced by a budget cap: (1) alg_paced_budget, and (2) alg_paced_imps. Due to the pacing service 216, service doesn't have algorithmic level spend information, the bidAlgo budget cap may be carried out by the checkAlgoDailyPacedBudget method in the MDP online adaptive performance service 214 (also referred to as kpiPerf service 214).

The online adaptive performance service 230 receives both the current and previous snapshots 211 of the pacing service 216 stats via an observer pattern that synchronizes the refresh of the online adaptive performance service 214 (producing KPI States 218) with the refresh of the pacing service 216 (producing bidAllocs).

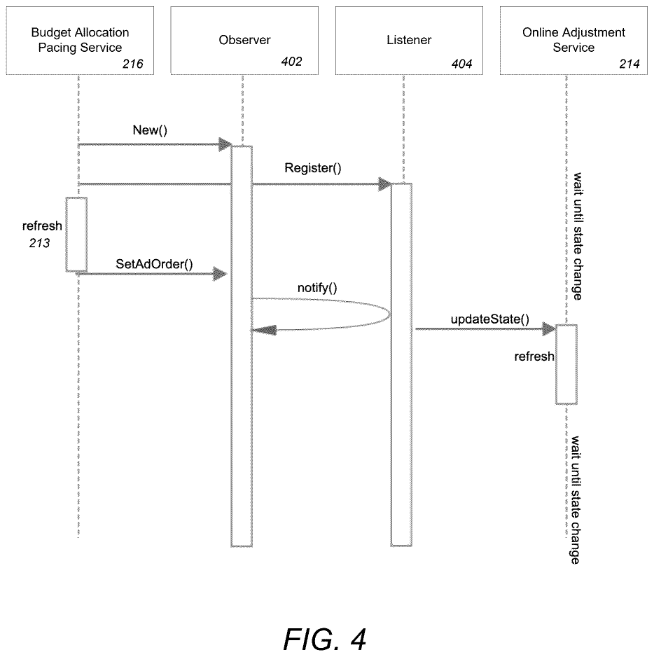

FIG. 4 illustrates the observer pattern workflow to synchronize a budget allocation/pacing service 216 with a bid optimizer online adjustment service 214 in the MDP 202 in accordance with one or more embodiments of the invention. As illustrated, upon a refresh 213 of each bid cycle, the pacing service 216 issues a new request to the observer 402 that registers the new request with the listener 404. The refresh 213 also sets an advertisement order with the observer 402. The observer 402 notifies the listener 404 of the advertisement order being set to trigger the online adjustment service 214 to update its state. In this regard, the online adjustment service 214 is waiting until a notification of the state change is received from the pacing service 216.

### Backward Compatibility to Pacing (Pacing Service 216)/Front Loading and Other Budget Constraints

In order to provide precise metrics to the numerical algorithm, an accurate bidding Algorithm daily budget/impression cap value may be needed for each refresh cycle 213. Due to the complexity of budget constraints, this value may keep changing over the day and needs to be consistent with the daily constraints used by the online adjustment service 216. Under demand-side budget separation (isolated metric), a bidding algorithm with end-to-end price adjustment may not need to follow the budget pacing curve (i.e., pctServingTimeElapsed), instead, it would follow its own pace by tracking delivery according to pctTimeElapsed. To do this, the bidding algorithm's daily budget constraint formula may be needed during the pacing hours with/without front-loading.

### Bid Optimizer Offer Price Adjustment

In an OpenRTB environment, determining the optimal offer price presents multiple challenges, including but not limited to asymmetric information between bidders and sellers, bid shading strategies, difficulties in assessing the return on bidding opportunities, and highly fluid supply-demand dynamics. To address these challenges, embodiments of the invention introduce a fully autonomous dynamic offer price adjustment system powered by artificial intelligence (AI) models, including a Machine Learning (ML) Win Price Model 244 and ML KPI models 246, collectively referred to as the “Bid Optimizer.”

A ML Win Price Model 244 (also referred to as a bid price win combination model) is a deep learning-based predictive model designed to determine optimal bidding prices in both first-price and second-price OpenRTB auctions by capturing feature patterns and data variations present in RTB bid requests. To address information asymmetry in first-price auctions, mitigate potential inflation and improve the accuracy of bid predictions, the bid-price win combination model 244 applies a heuristic label adjustment to the training dataset (e.g., input data 238), which consists of historical winning prices. The adjustment considers key factors such as website domains and bid floor prices, ensuring the optimal price falls between the bid floor and historical winning prices. Statistical methods further refine this adjustment by identifying patterns across website categories.

In one or more embodiments, a price adjustment variable may be used to adjust mediator 204 price bids. In this regard, for each time slot, the MDP 202 may produce order-level price adjustment variables (e.g., an adjustment ratio), which the mediator 204 applies when responding to eligible RTB bid requests (e.g., from the SSP 220). The mediator 204 first computes an adjusted maximum bid:

adjustedMaxBid=adjustmentRatio*maxBid

As an example, if the maxBid=$4.50 and the adjustmentRatio=0.6, the adjusted max bid may be adjustedMaxBid=$2.70. If the request bidFloor exceeds the adjustedMaxBid, the mediator 204 returns no-bid. Otherwise, it computes an adjusted offer as adjustmentRatio*MLWinPrice, and clamps the final offer to be within [bidFloor, adjustedMaxBid]:

$$finalOffer = min ( adjustedMaxBid , max ( bidFloor , adjustmentRatio * MLWinPrice ) )$$

Examples of an adjusted max bid and adjusted offer price include:

$$MLWinPrice = \$2 \text{.00} , bidFloor = \$1 \text{.30} \text{=>} adjustedOffer = 0.6 * 2. = \$1 \text{.20} \text{=>} finalOffer = \$1 \text{.30} \qquad ( i )$$

$$bidFloor = \$3 \text{.50} with adjustedMaxBid = \$2 \text{.70} \text{=>} no - bid \qquad ( ii )$$

While the bidding price predicted by the ML Win Price Model 244 effectively balances cost savings and a reasonable winning rate, the “Bid Optimizer” enhances its applicability by dynamically adjusting predicted bid prices to meet the varying demands of different advertising campaigns. By incorporating real-time factors such as campaign budget pacing and predicted KPI performance (e.g., via KPI Prediction Models 146), the Bid Optimizer ensures that bid prices are strategically adjusted to maximize auction success when necessary while minimizing costs when winning is less critical.

One innovation of the Bid Optimizer is the incorporation of time-slot evaluation metrics as feedback signals to assess its performance. Depending on the specific operational scenario, the following evaluation metrics are utilized to quantify the effectiveness of the Bid Optimizer in achieving its optimization objectives at a given time slot t:

### Scenario 1

If the only goal of Bid Optimizer is budget delivery, the following evaluation metric may be utilized:

$$EvalMetri {c}_{t} = {budget\_spent}_{t} / {pacedBudget}_{t} , when delivery < 100 \% ,$$

$$penalizing under pacing$$

$${EvalMetric}_{t} = ( {pacedBudget}_{t} * 2 - {budget\_spent}_{t} ) / {pacedBudget}_{t} ,$$

$$when delivery >= 100 \% , penalizing over pacing$$

### Scenario 2

If the goal include both KPI optimization (like CTR [click thru rate], VCR [video completion rate]) and budget delivery:

In some implementations, σ is a non-linear function that maps 1.0 to 1.0, and maps both 0 and +∞ to 0, for example, 1−tan h²(log (x))

When delivery <100%:

$$EvalMetrict = w * σ ( {actual\_kpi}_{t} / {target\_kpi}_{t} ) + ( 1 - w ) * {budget\_spent}_{k} / {pacedBudget}_{k}$$

$$When delivery >= 100 \% :$$

$$EvalMetri {c}_{t} = w * σ ( {actual\_kpi}_{t} / {target\_kpi}_{t} ) + ( 1 - w ) * ( pacedBudge {t}_{t} * 2 - {budget\_spent}_{t} ) / {pacedBudget}_{t}$$

In which w represents the weight between 0 and 1

In either of the scenarios, the evaluation metric is upper-bounded by 1.0:

$$EvalMetrict <= 1. .$$

In addition to the continuous evaluation metric, embodiments of the invention two binary state variables to classify delivery and performance outcomes.

Specifically, the Delivery State S_{d}∈{±1} and the Performance State Sₚ∈{±1} are defined as follows:
S_{d}=1 indicates an over-delivery state, and S_{d}=−1 indicates an under-delivery state. Similarly, Sₚ=1 represents an over-performing state, while Sₚ=−1corresponds to an under-performing state.

Another innovation of the Bid Optimizer is its autonomous online learning algorithm (also referred to as the online adjustment service 114), which dynamically updates, on a per-order basis, one or more Price Adjustment Variables—including the adjustment ratio and KPI slope—for use in real-time bidding. In one or more embodiments, the online learning algorithm is configured to support multi-objective optimization (e.g., jointly achieving budget delivery and KPI performance) by adjusting the Price Adjustment Variables based on time-slot feedback signals. The detailed methodology of this algorithm is described below, and the following section describes how the Price Adjustment Variables are applied to adjust offer prices:

If only the budget pacing is considered, the adjusted offer price of Bid Optimizer takes the following form:

$$BidOptOfferPrice = MLWinPrice * adjustmentRatio$$

If both budget pacing and KPI optimization are considered, the adjusted offer price takes the form:

$$BidOptOfferPrice = MLWinPrice * ( adjustmentRatio + normalizedKpi * kpiSlope ) ,$$

$$in which normalizedKpi = ( MLKpiPrediction - targetKpi ) / targetKpi$$

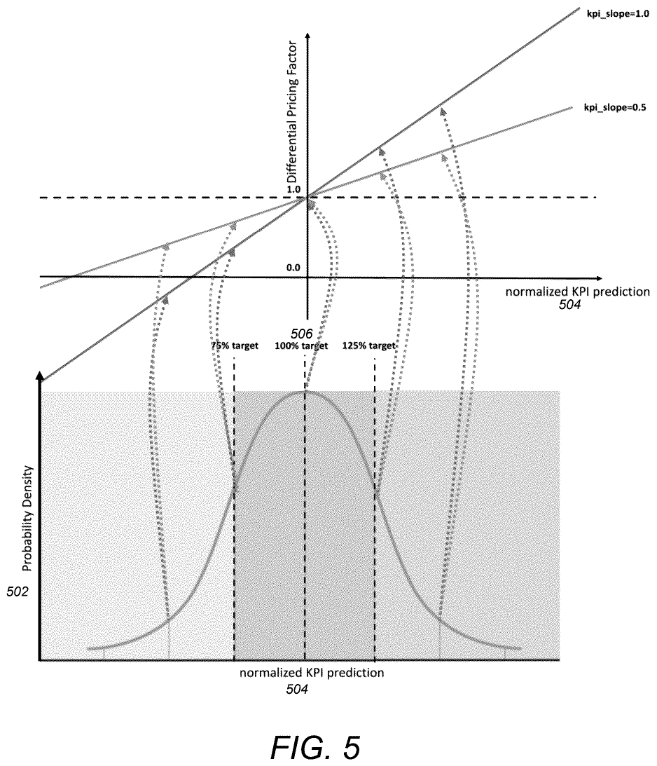

The presence of kpiSlope offers additional leverage for adjusting the price based on the predicted KPI 504 compared to the target KPI (see FIG. 5). More specifically, FIG. 5 illustrates a graph of the KPI slope in accordance with one or more embodiments of the invention. As illustrated, FIG. 5 shows that KPI slope controls the sensitivity of price adjustments to deviations between predicted KPI 504 and a target KPI 506. Predicted KPI values 504 produced by the ML KPI model across a population of bid opportunities typically follow an empirical distribution that is concentrated near the central tendency (e.g., the mean); equivalently, the probability density 502 of predicted KPI values 504 is higher near the center of the distribution than in the tails. With the adjustment ratio fixed at 1.0, and with the target KPI 506 set at or near the mean predicted KPI 504, most impressions receive small adjustments, while tail cases receive larger adjustments. Higher KPI slope (e.g., 1.0 vs 0.5) increases price differentiation-raising bids more for high predicted KPI opportunities and lowering bids more for low predicted KPI opportunities.

The final offer price takes the following form:

$$finalOfferPrice = min ( max ( BidOptOfferPrice , bidFloor ) , bidCeiling )$$

### Autonomous Online Learning of Price Adjustment Variables

Since the algorithm directly controls offer prices in real-world OpenRTB bidding, where each bidding transaction can directly impact an advertiser's media costs and profits, ensuring its reliability is of critical importance. While alternative algorithms exist, they may be less reliable or impose higher computational costs. Embodiments of the invention provide a simple yet effective algorithm to minimize latency while reducing integration costs within existing systems.

### Mathematical Modeling of Adjustment Ratio, KPI Slope, and Evaluation Metrics

Each order within an advertising campaign has two distinct price adjustment variables: x (the adjustment ratio) and y (the KPI slope)—x and y are assumed to be linearly independent, and each combination (x,y) is represented as a point in a two-dimensional domain R². Furthermore, it is assumed that x is exclusively responsible for budget delivery, whereas y is exclusively responsible for KPI performance. Thus the mathematical model can be expressed as a function ƒ: R²→R, where ƒ(x,y) quantifies the evaluation metric based on the inputs of x and y respectively.

As described above, FIG. 3 illustrates a mathematical model 316 of the adjustment ratio 312, KPI Slope 314, and Evaluation Metrics 310 in accordance with one or more embodiments of the invention. Referring to FIG. 3, in an exemplary implementation, a two-dimensional quadratic function ƒ(x,y)=ax²+bx+cy²+dy is employed to model the relationship among adjustment ratio x 312, KPI slope y 314 and the evaluation metric ƒ(x,y) 310. By definition, the quadratic function passes through the origin point ∫(0,0)=0. It is also required that the function is concave, and has a global maximum value of 1.0 at (xₒₚₜ, yₒₚₜ)=(−b/2,−d/2c).

In addition to using ƒ(x,y) to approximate the evaluation metric from historical data, one notable advantage is that the planes defined by x=xₒₚₜ=−b/2a (i.e., plane 318) and y=yₒₚₜ=−d/2c (i.e., plane 320) naturally form two separable hyperplanes. These hyperplanes 318-320 serve as decision boundaries for binary classification, where the signs sign (x−xₒₚₜ)=sign (x+b/2a)∈{±1} and sign (y−yₒₚₜ)=sign (y+d/2c)∈{±1} indicate class membership. Specifically, if x+b/2a is positive, the data point is classified as an over-delivery class 304; otherwise, it belongs to the opposite class 302. Likewise, if y+d/2c is positive, the data point is classified as an overperforming class 308; otherwise, it belongs to the opposite class 306.

This formulation enables an efficient approach that simultaneously addresses both regression (through ƒ(x,y)) and binary classification (through the hyperplane separations).

### Online Learning of Optimal Price Adjustment Variables Via Constrained Optimization

The online learning process for optimizing price adjustment variables is formulated as a constrained optimization problem that minimizes a hybrid loss function, which comprises a quadratic regression loss, a hinge loss, and an equality constraint.

For each order, the algorithm maintains a historical record of up to T=10 time steps, including their evaluation metrics, price adjustment variables, and binary states. More specifically, at each time step t, for an individual order within a given advertising campaign, the algorithm retrieves the following historical data:
Continuous variables history: (z_{t-T}, x_{t-T}, y_{t-T}), . . . , (zₜ₋₁, xₜ₋₁, yₜ₋₁), where zₜ, xₜ, yₜ represent evaluation metric, adjustment ratio and KPI slope at time step t, respectively. These values are utilized to compute the quadratic regression loss that quantifies approximation error of the evaluation metric.
Binary state history: (S^{(t-T)}_{d}, S^{(t-T)}ₚ), . . . , (S^{(t-1)}_{d}, S^{(t-1)}ₚ), where S^{(t)}_{d}∈{±1} represents the delivery state and S^{(t)}ₚ∈{±1} represents the performance state at time t. These binary state labels are used to compute the hinge loss, which enforces classification consistency for over/under-delivery and over/under-performance scenarios.

By minimizing the hybrid loss function within the following constrained optimization framework, the algorithm adaptively updates the price adjustment variables in real time, ensuring improved bid efficiency and enhanced KPI performance while remaining consistent to predefined constraints.

If the only goal of Bid Optimizer is budget delivery, the constrained optimization problem only needs to concern adjustment ratio x:

$$f ( x ) = a {x}^{2} + b x , f ( 0 ) = 0 , arg {max}_{x} ( f ) = 1.$$

Given data points {(xᵢ, zᵢ, S_{d,i})}_{i=1 . . . n}, the hybrid loss function takes the following form:

$$L ( a , b ) = \frac{1}{n} {\sum }_{i = 1}^{n} {( {z}_{i} - ( a {x}_{i}^{2} + b {x}_{i} ) )}^{2} ( MSE term ) + λ \frac{1}{n} {\sum }_{i = 1}^{n} {( max ( 0 , - {S}_{d , i} ( {x}_{i} - {x}_{opt} ) ) )}^{2} ( ( squared ) Hinge - loss term ) + {α ( 4 a + {b}^{2} - 1 )}^{2} ( equality constraint )$$

$$where {x}_{opt} = \frac{- b}{2 a}$$

in which λ and α are weighting factors for the hinge-loss and constraint terms, respectively.

If the goals of Bid Optimizer include both budget delivery and KPI optimization, the following constrained optimization problem concerning both adjustment ratio x and KPI slope y is applied:

$$f ( x , y ) = a {x}^{2} + b x + c {y}^{2} + d y , f ( 0 , 0 ) = 0 , arg {max}_{x , y} ( f ) = 1.$$

Given data points {(xᵢ,yᵢ,zᵢ,S_{d,i},S_{p,i})}_{i=1 . . . n}, the hybrid loss function takes the following form:

$$L ( a , b , c , d ) = \frac{1}{n} {\sum }_{i = 1}^{n} {( {z}_{i} - f ( {x}_{i} , {y}_{i} ) )}^{2} ( mean - squared error ( MSE ) ) + λ \frac{1}{n} {\sum }_{i = 1}^{n} [ {max ( 0 , - {S}_{d , i} ( {x}_{i} - {x}_{opt} ) )}^{2} + max {( 0 , - {S}_{p , i} ( {y}_{i} - {y}_{opt} ) )}^{2} ] ( ( squared ) hinge loss in 2 D ) + {α ( f ( {x}_{opt} , {y}_{opt} ) - 1 )}^{2} ( equality constraint ; peak = 1 )$$

$$where {x}_{opt} = - \frac{b}{2 a} , {y}_{opt} = - \frac{d}{2 c}$$

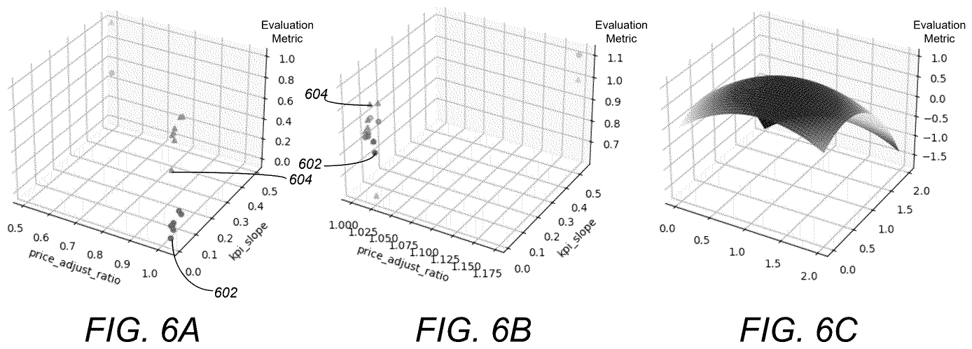

Starting with a default value of a, b, c, d the constrained optimization process firstly probes with different gradient decent step sizes and chooses the optimal one to perform gradient descent up to N (e.g., N=100) iterations to ensure convergence. FIGS. 6A-6C illustrate the iterative constrained optimization process for fitting a quadratic function to sample data points in accordance with one or more embodiments of the invention. Circle points 602 represent ƒ(x,y) values and triangle points 604 denote actual observed values. More specifically, FIG. 6A illustrates initial sample points, FIG. 6B illustrates sample points at convergence, and FIG. 6C illustrates function ƒ(x,y) at convergence.

### Constraints on Price Adjustment Variables

To ensure that the adjustment ratio x and KPI slope y remain within an acceptable range and within the solvable region of the constrained optimization problem, guardrails are implemented to enforce upper and lower bounds on these price adjustment variables. This approach prevents excessive deviations and maintains the stability and feasibility of the optimization process.

### Logical Flow

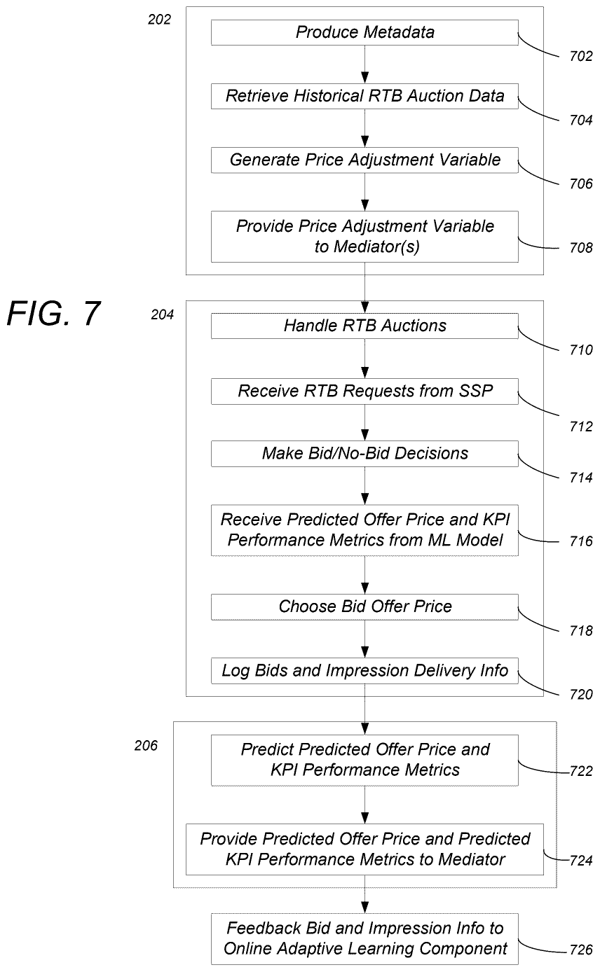

FIG. 7 illustrates the logical flow for optimizing a bid in a real time bid (RTB) auction.

Steps 702-708 are performed by a metadata producer (MDP) application 202. The MDP application 202 includes an online adaptive learning component configured to autonomously, perform the steps at predefined time interval cycles. Specifically, at step 702, MDP application 202 produces campaign metadata including budget pacing.

At step 704, MDP application 202 retrieves historical RTB auction data including a snapshot of any prior interval cycles.

At step 706, MDP application 202 generates a price adjustment variable for adjusting a bid offer price based on the historical RTB auction data and the campaign metadata.

At step 708, MDP application 202 provides the price adjustment variable to one or more mediator applications 204.

In one or more embodiments, the online adaptive learning component (of MDP application 202) dynamically optimizes the price adjustment variable for individual orders within advertising campaigns.

Steps 710-720 are performed by one or more mediator applications 204.

At step 710, mediator applications 204 handle RTB auctions including submitting a bid within the RTB auction.

At step 712, mediator applications 204 receive RTB requests from a supply side platform (SSP).

At step 714, mediator applications 204 make bid/no-bid decisions.

At step 716, mediator applications 204 receive a predicted offer price and predicted key performance index (KPI) performance metrics from a machine learning

(ML) model.

At step 718, mediator applications 204 choose the bid offer price based on the price adjustment variable generated by the MDP, and the predicted offer price and predicted KPI performance metrics received from the ML model.

At step 720, mediator applications 204 log bids and impression delivery information.

In one or more embodiments, the MDP 202 dynamically adjusts the price adjustment variable to meet demands of different advertising campaigns. In such embodiments, and the mediator application(s) 204 dynamically adjust the bid offer price based on the dynamically adjusted price adjustment variable.

In addition, MDP 202 may perform different processes depending on the scenario. For example, when budget delivery is the only goal considered by the MDP, the online adaptive learning component optimizes an adjustment ratio when generating the price adjustment variable. Alternatively, when both budget pacing and KPI optimization are goals considered by the MDP, the online adaptive learning component optimizes both an adjustment ratio and a KPI slope when generating the price adjustment variable.

Further to the above, in one or more embodiments of the invention, an objective of the online adaptive learning component is to learn the price adjustment variable using gradient descent. In such embodiments, the online adaptive learning component formulates a process for optimizing the price adjustment variable as a constrained optimization problem that minimizes a hybrid loss function. Such a hybrid loss function consists of a quadratic regression loss, a hinge loss, and an equality constraint. Further, the hybrid loss function is minimized resulting in an updated price adjustment variable in real time by the online adaptive learning component.

Steps 722-724 are performed by an ML Model 206 (e.g., a TensorFlow ML model).

At step 722, a win-price prediction model (of the ML model 206) predicts the predicted offer price to win an RTB auction. In one or more embodiments, the win-price prediction model consists of a deep learning based predictive model that determines the predicted offer price in both first-price and second price RTB auctions by capturing feature patterns and data variations present in the RTB bid requests.

In one or more embodiments, a training dataset for the win-price prediction model includes historical winning prices. The win-price prediction model may then apply a heuristic label adjustment to the training dataset. The heuristic label adjustment considers factors such that the predicted offer price falls between a bid floor and the historical winning prices. In addition, the ML model may refine the heuristic label adjustment using a statistical method that identifies a pattern across website categories.

At step 724, a KPI prediction model (of the ML Model 206) predicts the KPI performance metrics.

At step 726, the ML Model 206 provides the predicted offer price and predicted KPI performance metrics to the mediator application 204.

At step 728, a feedback loop provides the bids and impression delivery information from the mediator application 204 to the online adaptive learning component of the MDP application 202. In one or more embodiments, the bids and impression delivery information in the feedback loop include a time-slot evaluation metric that is utilized to quantify an effectiveness of the mediator application and the ML model. Thereafter, the online adaptive learning component utilizes the time-slot evaluation metric to adjust the price adjustment variable.

### Hardware Environment

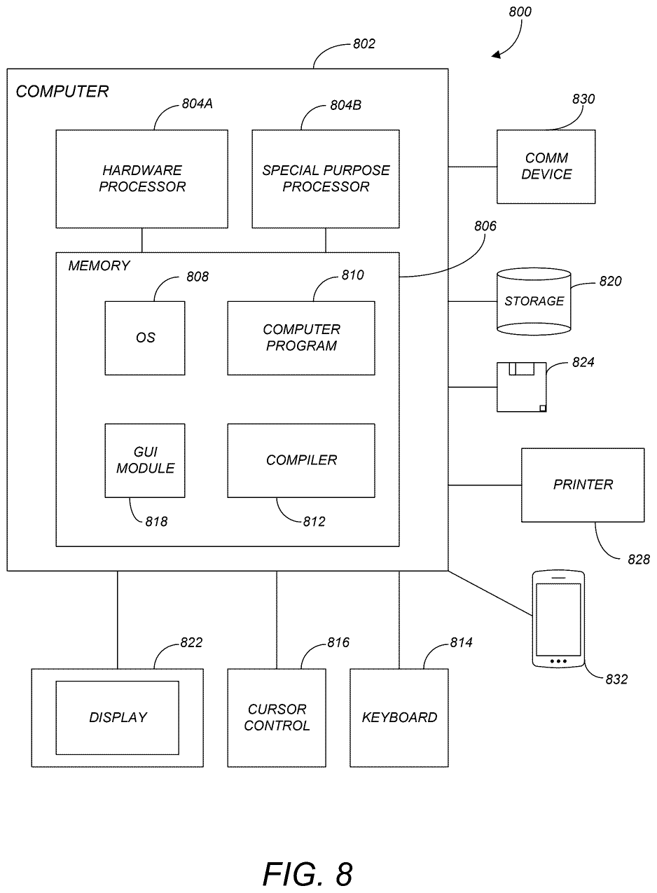

FIG. 8 is an exemplary hardware and software environment 800 (referred to as a computer-implemented system and/or computer-implemented method) used to implement one or more embodiments of the invention. The hardware and software environment includes a computer 802 and may include peripherals. Computer 802 may be a user/client computer, server computer, or may be a database computer. The computer 802 comprises a hardware processor 804A and/or a special purpose hardware processor 804B (hereinafter alternatively collectively referred to as processor 804) and a memory 806, such as random access memory (RAM). The computer 802 may be coupled to, and/or integrated with, other devices, including input/output (I/O) devices such as a keyboard 814, a cursor control device 816 (e.g., a mouse, a pointing device, pen and tablet, touch screen, multi-touch device, etc.) and a printer 828. In one or more embodiments, computer 802 may be coupled to, or may comprise, a portable or media viewing/listening device 832 (e.g., an MP3 player, IPOD, NOOK, portable digital video player, cellular device, personal digital assistant, etc.). In yet another embodiment, the computer 802 may comprise a multi-touch device, mobile phone, gaming system, internet enabled television, television set top box, or other internet enabled device executing on various platforms and operating systems.

In one embodiment, the computer 802 operates by the hardware processor 804A performing instructions defined by the computer program 810 (e.g., a computer-aided design [CAD] application) under control of an operating system 808.

The computer program 810 and/or the operating system 808 may be stored in the memory 806 and may interface with the user and/or other devices to accept input and commands and, based on such input and commands and the instructions defined by the computer program 810 and operating system 808, to provide output and results.

Output/results may be presented on the display 822 or provided to another device for presentation or further processing or action. In one embodiment, the display 822 comprises a liquid crystal display (LCD) having a plurality of separately addressable liquid crystals. Alternatively, the display 822 may comprise a light emitting diode (LED) display having clusters of red, green and blue diodes driven together to form full-color pixels. Each liquid crystal or pixel of the display 822 changes to an opaque or translucent state to form a part of the image on the display in response to the data or information generated by the processor 804 from the application of the instructions of the computer program 810 and/or operating system 808 to the input and commands. The image may be provided through a graphical user interface (GUI) module 818. Although the GUI module 818 is depicted as a separate module, the instructions performing the GUI functions can be resident or distributed in the operating system 808, the computer program 810, or implemented with special purpose memory and processors.

In one or more embodiments, the display 822 is integrated with/into the computer 802 and comprises a multi-touch device having a touch sensing surface (e.g., track pod, touch screen, smartwatch, smartglasses, smartphones, laptop or non-laptop personal mobile computing devices) with the ability to recognize the presence of two or more points of contact with the surface. Examples of multi-touch devices include mobile devices (e.g., IPHONE, ANDROID devices, WINDOWS phones, GOOGLE PIXEL devices, NEXUS S, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 802 according to the computer program 810 instructions may be implemented in a special purpose processor 804B. In this embodiment, some or all of the computer program 810 instructions may be implemented via firmware instructions stored in a read only memory (ROM), a programmable read only memory (PROM) or flash memory within the special purpose processor 804B or in memory 806. The special purpose processor 804B may also be hardwired through circuit design to perform some or all of the operations to implement the present invention. Further, the special purpose processor 804B may be a hybrid processor, which includes dedicated circuitry for performing a subset of functions, and other circuits for performing more general functions such as responding to computer program 810 instructions. In one embodiment, the special purpose processor 804B is an application specific integrated circuit (ASIC).

The computer 802 may also implement a compiler 812 that allows an application or computer program 810 written in a programming language such as C, C++, Assembly, SQL, PYTHON, PROLOG, MATLAB, RUBY, RAILS, HASKELL, or other language to be translated into processor 804 readable code. Alternatively, the compiler 812 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 810 accesses and manipulates data accepted from I/O devices and stored in the memory 806 of the computer 802 using the relationships and logic that were generated using the compiler 812.

The computer 802 also optionally comprises an external communication device such as a modem, satellite link, Ethernet card, or other device for accepting input from, and providing output to, other computers 802.

In one embodiment, instructions implementing the operating system 808, the computer program 810, and the compiler 812 are tangibly embodied in a non-transitory computer-readable medium, e.g., data storage device 820, which could include one or more fixed or removable data storage devices, such as a zip drive, floppy disc drive 824, hard drive, CD-ROM drive, tape drive, etc. Further, the operating system 808 and the computer program 810 are comprised of computer program 810 instructions which, when accessed, read and executed by the computer 802, cause the computer 802 to perform the steps necessary to implement and/or use the present invention or to load the program of instructions into a memory 806, thus creating a special purpose data structure causing the computer 802 to operate as a specially programmed computer executing the method steps described herein. Computer program 810 and/or operating instructions may also be tangibly embodied in memory 806 and/or data communications devices 830, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 802.

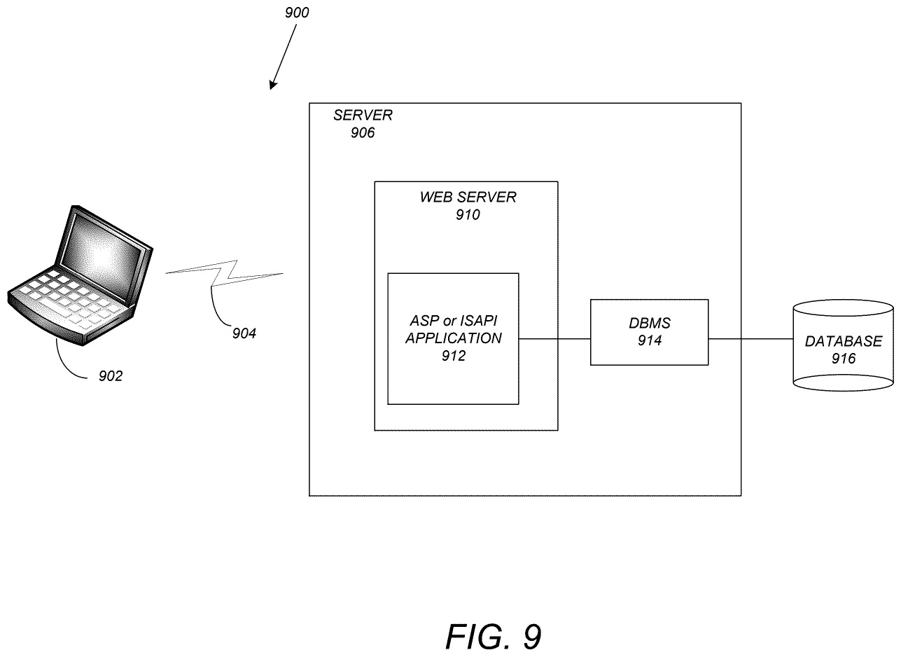

FIG. 9 schematically illustrates a typical distributed/cloud-based computer system 900 using a network 904 to connect client computers 902 to server computers 906. A typical combination of resources may include a network 904 comprising the Internet, LANs (local area networks), WANs (wide area networks), SNA (systems network architecture) networks, or the like, clients 902 that are personal computers or workstations (as set forth in FIG. 8), and servers 906 that are personal computers, workstations, minicomputers, or mainframes (as set forth in FIG. 8). However, it may be noted that different networks such as a cellular network (e.g., GSM [global system for mobile communications] or otherwise), a satellite based network, or any other type of network may be used to connect clients 902 and servers 906 in accordance with embodiments of the invention.

A network 904 such as the Internet connects clients 902 to server computers 906. Network 904 may utilize ethernet, coaxial cable, wireless communications, radio frequency (RF), etc. to connect and provide the communication between clients 902 and servers 906. Further, in a cloud-based computing system, resources (e.g., storage, processors, applications, memory, infrastructure, etc.) in clients 902 and server computers 906 may be shared by clients 902, server computers 906, and users across one or more networks. Resources may be shared by multiple users and can be dynamically reallocated per demand. In this regard, cloud computing may be referred to as a model for enabling access to a shared pool of configurable computing resources.

Clients 902 may execute a client application or web browser and communicate with server computers 906 executing web servers 910. Such a web browser is typically a program such as MICROSOFT INTERNET

EXPLORER/EDGE, MOZILLA FIREFOX, OPERA, APPLE SAFARI, GOOGLE CHROME, etc. Further, the software executing on clients 902 may be downloaded from server computer 906 to client computers 902 and installed as a plug-in or ACTIVEX control of a web browser. Accordingly, clients 902 may utilize ACTIVEX components/component object model (COM) or distributed COM (DCOM) components to provide a user interface on a display of client 902. The web server 910 is typically a program such as MICROSOFT'S INTERNET INFORMATION SERVER.

Web server 910 may host an Active Server Page (ASP) or Internet Server Application Programming Interface (ISAPI) application 912, which may be executing scripts. The scripts invoke objects that execute business logic (referred to as business objects). The business objects then manipulate data in database 916 through a database management system (DBMS) 914. Alternatively, database 916 may be part of, or connected directly to, client 902 instead of communicating/obtaining the information from database 916 across network 904. When a developer encapsulates the business functionality into objects, the system may be referred to as a component object model (COM) system. Accordingly, the scripts executing on web server 910 (and/or application 912) invoke COM objects that implement the business logic. Further, server 906 may utilize MICROSOFT'S TRANSACTION SERVER (MTS) to access required data stored in database 916 via an interface such as ADO (Active Data Objects), OLE DB (Object Linking and Embedding DataBase), or ODBC (Open DataBase Connectivity).

Generally, these components 900-916 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 902 and 906 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 902 and 906. Embodiments of the invention are implemented as a software/CAD application on a client 902 or server computer 906. Further, as described above, the client 902 or server computer 906 may comprise a thin client device or a portable device that has a multi-touch-based display.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

In summary, embodiments of the invention provide an ML win price model that provides a reasonable estimation of winnable price with partially observed information (e.g., an auction type 1). Such an ML win price model enables the ability to provide a bid resulting in significant improvements in media cost savings across a percent of spend and fixed price customers.

The ML win-price model predicts optimal bidding prices on the supply side, taking into account the inherent variability and patterns in bid requests. Such capabilities provide numerous innovations including: (a) Price Label Adjustment; and (b) Joint training of win-price and win-rate.

With respect to the Price Label Adjustment-to address potential inflation in past winning prices, the model uses a heuristic to adjust price labels. This adjustment considers key factors such as website domains and bid floor prices, aiming to position the optimal price between the bid floor and past winning prices. Statistical methods are applied to identify patterns within website categories to refine this adjustment.

With respect to the joint training of win-price and win-rate-the training data includes a diverse set of winning and lost bid prices, reflecting real-world variability influenced by ad selection, price sources, and other factors. This eliminates the need for manual price creation, as the model learns directly from the variability in observed prices and win rates.

To provide the above innovations and capabilities including auto-adjustment, embodiments of the invention provide an online learning auto-adjust algorithm. As a learning agent (defined as a parameterized mathematic function) faces a dynamically changing environment (like RTB bidding), the learning agent doesn't know what would happen in the future, but it could interact with the environment via actions (e.g. changing certain adjustment values) and could receive responses from the environment via a feedback loop (for instance, the agent could take measurements from the environment after taking its latest actions). Thus, the agent learns (e.g. updating function parameters) to quickly adapt to the changing environment based on feedback from its most recent actions.

To enhance the robustness of the online learning, various processes may be utilized. For example, to improve its robustness to noisy inputs, the online learning algorithm may leverage a hybrid loss function (quadratic loss+hinge loss). Further, an optimization of the online learning minimizes total loss among recent observations from each ad order. Such a minimization may be enabled by performing a step-size search before gradient descent.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented system for optimizing a bid in a real time bid (RTB) auction comprising:
(a) a computer having a memory;
(b) a processor executing on the computer;
(c) the memory storing a set of instructions, wherein the set of instructions, when executed by the processor cause the processor to perform operations;
(d) a metadata producer (MDP) application, executed via the operations on the processor, wherein the MDP application comprises an online adaptive learning component configured to autonomously, at predefined time interval cycles:
(i) produce campaign metadata including budget pacing;
(ii) retrieve historical RTB auction data including a snapshot of any prior interval cycles;
(iii) generate a price adjustment variable for adjusting a bid offer price based on the historical RTB auction data and the campaign metadata; and
(iv) provides the price adjustment variable to one or more mediator applications;
(e) the one or more mediator applications, executed via the operations on the processor, wherein the one or more mediator applications:
(i) handle RTB auctions including submitting a bid within the RTB auction;
(ii) receive RTB requests from a supply side platform (SSP);
(iii) make bid/no-bid decisions;
(iv) receive a predicted offer price and predicted key performance index (KPI) performance metrics from a machine learning (ML) model;
(v) choose the bid offer price based on the price adjustment variable generated by the MDP, and the predicted offer price and predicted KPI performance metrics received from the ML model; and
(vi) log bids and impression delivery information;
(f) the machine learning (ML) model, executed via the operations on the processor, wherein the ML model:
(i) includes a win-price prediction model that predicts the predicted offer price to win an RTB auction;
(ii) includes a KPI prediction model that predicts the KPI performance metrics; and
(iii) provides the predicted offer price and predicted KPI performance metrics to the mediator application; and
(g) a feedback loop, executed via the operations on the processor, wherein the feedback loop provides the bids and impression delivery information from the mediator application to the online adaptive learning component of the MDP application.

2. The computer-implemented system of claim 1, wherein the win-price prediction model comprises:
a deep learning based predictive model that determines the predicted offer price in both first-price and second price RTB auctions by capturing feature patterns and data variations present in the RTB bid requests.

3. The computer-implemented system of claim 1, wherein:
a training dataset for the win-price prediction model comprises historical winning prices;
the win-price prediction model applies a heuristic label adjustment to the training dataset;
the heuristic label adjustment considers factors such that the predicted offer price falls between a bid floor and the historical winning prices.

4. The computer-implemented system of claim 3, further comprising:
the ML model refining the heuristic label adjustment using a statistical method that identifies a pattern across website categories.

5. The computer-implemented system of claim 1, wherein:
the MDP dynamically adjusts the price adjustment variable to meet demands of different advertising campaigns; and
the mediator dynamically adjusts the bid offer price based on the dynamically adjusted price adjustment variable.

6. The computer-implemented system of claim 1, wherein:
the bids and impression delivery information in the feedback loop comprise a time-slot evaluation metric that is utilized to quantify an effectiveness of the mediator application and the ML model;
the online adaptive learning component utilizes the time-slot evaluation metric to adjust the price adjustment variable.

7. The computer-implemented system of claim 1, wherein the online adaptive learning component:
dynamically optimizes the price adjustment variable for individual orders within advertising campaigns.

8. The computer-implemented system of claim 1, wherein:
budget delivery is the only goal considered by the MDP;
in generating the price adjustment variable, the online adaptive learning component optimizes an adjustment ratio.

9. The computer-implemented system of claim 1, wherein:
both budget pacing and KPI optimization are goals considered by the MDP;
in generating the price adjustment variable, the online adaptive learning component optimizes both an adjustment ratio and a KPI slope.

10. The computer-implemented system of claim 1, wherein:
an objective of the online adaptive learning component is to learn the price adjustment variable using gradient descent;
the online adaptive learning component formulates a process for optimizing the price adjustment variable as a constrained optimization problem that minimizes a hybrid loss function;
the hybrid loss function comprises a quadratic regression loss, a hinge loss, and an equality constraint;
the hybrid loss function is minimized resulting in an updated price adjustment variable in real time by the online adaptive learning component.

11. A computer-implemented method for optimizing a bid in a real time bid (RTB) auction comprising, comprising:
(a) a metadata producer (MDP) application, executed on a computer, wherein the MDP application comprises an online adaptive learning component configured to autonomously, at predefined time interval cycles:
(i) produce campaign metadata including budget pacing;
(ii) retrieve historical RTB auction data including a snapshot of any prior interval cycles;
(iii) generate a price adjustment variable for adjusting a bid offer price based on the historical RTB auction data and the campaign metadata; and
(iv) provides the price adjustment variable to one or more mediator applications;
(b) the one or more mediator applications, executed on the computer, wherein the one or more mediator applications:
(i) handle RTB auctions including submitting a bid within the RTB auction;
(ii) receive RTB requests from a supply side platform (SSP);
(iii) make bid/no-bid decisions;
(iv) receive a predicted offer price and predicted key performance index (KPI) performance metrics from a machine learning (ML) model;
(v) choose the bid offer price based on the price adjustment variable generated by the MDP, and the predicted offer price and predicted KPI performance metrics received from the ML model; and
(vi) log bids and impression delivery information;
(f) the machine learning (ML) model, executed on the computer, wherein the ML model:
(i) includes a win-price prediction model that predicts the predicted offer price to win an RTB auction;
(ii) includes a KPI prediction model that predicts the KPI performance metrics; and
(iii) provides the predicted offer price and predicted KPI performance metrics to the mediator application; and
(g) a feedback loop, executed via the computer, wherein the feedback loop provides the bids and impression delivery information from the mediator application to the online adaptive learning component of the MDP application.

12. The computer-implemented method of claim 11, wherein the win-price prediction model comprises:
a deep learning based predictive model that determines the predicted offer price in both first-price and second price RTB auctions by capturing feature patterns and data variations present in the RTB bid requests.

13. The computer-implemented method of claim 11, wherein:
a training dataset for the win-price prediction model comprises historical winning prices;
the win-price prediction model applies a heuristic label adjustment to the training dataset;
the heuristic label adjustment considers factors such that the predicted offer price falls between a bid floor and the historical winning prices.

14. The computer-implemented method of claim 13, further comprising:
the ML model refining the heuristic label adjustment using a statistical method that identifies a pattern across website categories.

15. The computer-implemented method of claim 11, wherein:
the MDP dynamically adjusts the price adjustment variable to meet demands of different advertising campaigns; and
the mediator dynamically adjusts the bid offer price based on the dynamically adjusted price adjustment variable.

16. The computer-implemented method of claim 11, wherein:
the bids and impression delivery information in the feedback loop comprise a time-slot evaluation metric that is utilized to quantify an effectiveness of the mediator application and the ML model;
the online adaptive learning component utilizes the time-slot evaluation metric to adjust the price adjustment variable.

17. The computer-implemented method of claim 11, wherein the online adaptive learning component:
dynamically optimizes the price adjustment variable for individual orders within advertising campaigns.

18. The computer-implemented method of claim 11, wherein:
budget delivery is the only goal considered by the MDP;
in generating the price adjustment variable, the online adaptive learning component optimizes an adjustment ratio.

19. The computer-implemented method of claim 11, wherein:
both budget pacing and KPI optimization are goals considered by the MDP;
in generating the price adjustment variable, the online adaptive learning component optimizes both an adjustment ratio and a KPI slope.

20. The computer-implemented method of claim 11, wherein:
an objective of the online adaptive learning component is to learn the price adjustment variable using gradient descent;
the online adaptive learning component formulates a process for optimizing the price adjustment variable as a constrained optimization problem that minimizes a hybrid loss function;
the hybrid loss function comprises a quadratic regression loss, a hinge loss, and an equality constraint;
the hybrid loss function is minimized resulting in an updated price adjustment variable in real time by the online adaptive learning component.
